(19) United States
(12) Patent Application Publication
(10) Pub. No.: US 2022/0127497 A1
(43) Pub. Date: Apr. 28, 2022

(54) WATER-DISPERSIBLE PAPER

(71) Applicant: NIPPON PAPER PAPYLIA CO., LTD., Fuji-shi, Shizuoka (JP)

(72) Inventors: Yoshiaki ISHINO, Chiyoda-ku, Tokyo (JP); Masaki KISHIMOTO, Chiyoda-ku, Tokyo (JP)

(21) Appl. No.: 17/428,956

(22) PCT Filed: Feb. 21, 2020
(86) PCT No.: PCT/JP2020/006980

§ 371 Date: Aug. 5, 2021

(30) Foreign Application Priority Data
Mar. 7, 2019 (JP) 2019-041083

(51) Int. Cl. C09J 7/21; C09J 7/38; C09J 7/20; C09J 11/08; C09J 11/04

(52) U.S. Cl. CPC C09J 7/21; C09J 7/38; C09J 7/205; C09J 2400/283; C09J 11/04; C09J 2483/00; C09J 11/08

(57) ABSTRACT

An object is to provide a water-dispersible paper that exhibits excellent dispersibility in water. As a solution, a water-dispersible paper is provided that has a base paper containing papermaking fibers and a water-soluble alkaline compound, wherein the Canadian Standard Freeness of the papermaking fibers is 500 ml CSF or higher but no higher than 750 ml CSF.

### TECHNICAL FIELD

The present invention relates to a water-dispersible paper, and more specifically to a water-dispersible paper that exhibits excellent dispersibility in water even after an adhesive layer or coating layer is provided thereon.

### BACKGROUND ART

Water-dispersible papers that disperse quickly in water (also referred to as “water-disintegrable papers” or “water-soluble papers”) are used widely in such applications as bathroom deodorizing sheets, packing papers, papers for confidential documents, and water-dispersible labels (Patent Literatures 1, 2, 3, etc.). Depending on their application, water-dispersible papers may have an adhesive layer, deodorizing agent layer, print receiving layer for enhancing printing performance/printability, or other coating layer comprising an aqueous coating material, provided at least on one side of the base paper.

Water-dispersible papers on which an adhesive layer or coating layer is provided inevitably have lower dispersibility in water compared to those comprising a base paper alone.

### BACKGROUND ART LITERATURE

### Patent Literature

Patent Literature 1: Japanese Patent Laid-open No. 2018-104860
Patent Literature 2: Japanese Patent Laid-open No. 2000-170100
Patent Literature 3: Japanese Patent Laid-open No. 2007-237634

### SUMMARY OF THE INVENTION

### Problems to be Solved by the Invention

An object of the present invention is to provide a water-dispersible paper that exhibits excellent dispersibility in water.

### Means for Solving the Problems

Factors that promote the dispersion in water of a water-dispersible paper when placed into water include the following:

1) Fibers dissociating from each other due to cleaving of hydrogen bonds between the fibers

2) Increase in inter-fiber gaps due to dissolution of water-soluble polymer coating layers

3) Increase in inter-fiber gaps due to swelling and dissolution of carboxyalkyl cellulose salts

4) Increase in inter-fiber gaps due to dropout of water-dispersible powders

As a result of earnestly studying how the dispersibility in water of a water-dispersible paper could be improved further, the inventors of the present invention found that, when its base paper uses papermaking fibers having a specific range of freeness and also contains a water-soluble alkaline compound for promoting the fibers separating from each other in water, a water-dispersible paper would achieve improved dispersibility in water, and that its dispersibility in water would increase further when a carboxyalkyl cellulose salt is contained, and eventually completed the present invention.

To be specific, the means for achieving the object of the present invention are as follows.

1. A water-dispersible paper, characterized by having a base paper containing papermaking fibers and a water-soluble alkaline compound, wherein the Canadian Standard Freeness of the papermaking fibers is 500 ml CSF or higher but no higher than 750 ml CSF.

2. The water-dispersible paper according to 1, characterized in that the base paper contains a carboxyalkyl cellulose salt.

3. The water-dispersible paper according to 1 or 2, characterized in that the base paper contains either of a water-insoluble powder and a marginally water-soluble powder or both.

4. The water-dispersible paper according to any one of 1 to 3, characterized by having an adhesive layer at least on one face.

5. The water-dispersible paper according to any one of 1 to 4, characterized by having a coating layer comprising an aqueous coating material at least on one face.

6. The water-dispersible paper according to 5, characterized by having the adhesive layer on one face, and the coating layer on the other face, of the base paper.

### Effects of the Invention

The water-dispersible paper proposed by the present invention exhibits excellent dispersibility of its base paper in water. Because of the excellent dispersibility in water of its base paper, the water-dispersible paper proposed by the present invention remains highly dispersible in water even after an adhesive layer or coating layer is provided thereon.

### MODE FOR CARRYING OUT THE INVENTION

The water-dispersible paper proposed by the present invention is characterized in that it has a base paper containing papermaking fibers and a water-soluble alkaline compound, wherein the Canadian Standard Freeness of the papermaking fibers is 500 ml CSF or higher but no higher than 750 ml CSF.

### [Base Paper]

The water-dispersible paper proposed by the present invention is such that its base paper contains papermaking fibers and a water-soluble alkaline compound, and if necessary, it contains either one or both of a water-insoluble powder and a marginally water-soluble powder. The water-dispersible paper proposed by the present invention is characterized in that it does not use any of the water-insoluble fibrous carboxyalkyl celluloses that are compounded when conventional water-soluble papers are made, and that higher dispersibility in water is added to it by the papermaking fibers and water-soluble alkaline compound. Furthermore, the water-dispersible paper proposed by the present invention is characterized in that it can achieve higher dispersibility in water when the base paper contains a water-soluble carboxyalkyl cellulose salt. Because its base paper is highly dispersible in water, the water-dispersible paper proposed by the present invention does not see its dispersibility in water drop much when an adhesive layer or coating layer is provided thereon.

Preferably the base paper has a small floc state dispersion time in water of within 100 seconds, and fibrous dispersion time in water of within 200 seconds, or more preferably the small floc state dispersion time in water is within 10 seconds and fibrous dispersion time in water is within 100 seconds, or yet more preferably the small floc state dispersion time in water is within 5 seconds and fibrous dispersion time in water is within 60 seconds.

Since the base paper is to have a coating layer comprising an adhesive or aqueous coating material provided thereon according to the purpose of use, its tensile strength per JIS P8113 is preferably 0.3 kN/m or higher, or more preferably 0.5 kN/m or higher. Although it varies depending on the basis weight, the upper limit of tensile strength must be in a range where the dispersibility in water is not affected, preferably no higher than 6.0 kN/m or so. Since yellowing caused by the water-soluble alkaline compound, etc., may lower the whiteness of the base paper and affect its appearance, the whiteness of the base paper is preferably 70 percent or higher, or more preferably 75 percent or higher.

### Papermaking Fibers

For the papermaking fibers used under the present invention, any wood pulp fibers or non-wood pulp fibers generally used in papermaking may be used. To be specific, wood pulp fibers include fibers from softwood kraft pulp, hardwood kraft pulp, dissolving pulp, mercerized pulp, etc., while non-wood pulp fibers include fibers from hemp pulp, manila hemp pulp, kenaf pulp, and other non-wood pulps as well as Lyocell and other refined cellulose fibers, etc., of which one type may be used alone or two or more types may be combined. Among these, softwood pulp is preferred when a water-dispersible sheet offering excellent strength is to be obtained, while hardwood pulp or dissolving pulp is preferred when a sheet having excellent dispersibility in water is to be obtained. The average fiber length of the papermaking fibers is not limited in any way, but preferably 0.1 mm or more but no more than 5 mm, or more preferably 0.5 mm or more but no more than 3 mm, or yet more preferably 0.8 mm or more but no more than 2 mm.

The Canadian Standard Freeness (hereinafter also referred to as “freeness”; value measured according to JIS P8121-2 2012) of the papermaking fibers is 500 ml CSF or higher but no higher than 750 ml CSF. When the fibers are beaten further (their freeness becomes lower), the fibers experience more fibrilization, breakage, and internal swelling, making the base paper denser, stronger, and smoother, while causing its dispersibility in water and air permeability to drop. The freeness of the papermaking fibers is preferably 550 ml CSF or higher but no higher than 720 ml CSF, or more preferably 600 ml CSF or higher but no higher than 700 ml CSF.

### Water-Soluble Alkaline Compound

The water-dispersible paper proposed by the present invention is such that its base paper contains a water-soluble alkaline compound. A water-soluble alkaline compound is a compound whose solubility in 25° C. water is 1 g or more per 100 g of solution, and whose aqueous solution with a mol concentration of 0.1 mol/L has a pH of 8.0 or higher. The water-soluble alkaline compound has the effect of producing an alkaline aqueous solution in water to cause the papermaking fibers in the base paper to swell, thereby promoting the cleaving of their hydrogen bonds to increase its dispersibility in water. Any water-soluble alkaline compound having the aforementioned effect may be used without specific limitations; however, specific examples include sodium hydroxide, potassium hydroxide, and other hydroxides of alkali metals, sodium carbonate, sodium hydrogen carbonate, and other carbonate salts/hydrogen carbonate salts of alkali metals, sodium hydrogen phosphate and other phosphate salts/hydrogen phosphate salts of alkali metals, sodium acetate and other organic acid salts of alkali metals, barium hydroxide and other hydroxides of alkali earth metals, ammonia and ammonium salts, triethanolamines and other amines, polyethyleneimines and other alkaline polymers of 1,000 or lower in molecular weight, etc., of which one type may be used alone or two or more types may be combined. The pH of the water-soluble alkaline compound is such that, when it is made into an aqueous solution with a concentration of 0.1 mol/L, its pH is 8.0 or higher, or preferably pH 9.0 to pH 12.0. Sodium carbonate having appropriate basicity and excellent solubility in water is preferred as the water-soluble alkaline compound.

Preferably the percentage of the water-soluble alkaline compound relative to the weight of the base paper is 0.1% by weight or higher but no higher than 16.0% by weight. If the percentage of the water-soluble alkaline compound is under 0.1% by weight, the effect of improving the dispersibility in water becomes poor; if it exceeds 16.0% by weight, on the other hand, the base paper tends to undergo discoloration, decrease in whiteness, and other changes in its appearance. More preferably the percentage of the water-soluble alkaline compound is 0.2% by weight or higher but no higher than 14.0% by weight. It should be noted that the percentage of the water-soluble alkaline compound relative to the weight of the base paper is adjusted as deemed appropriate according to, for example, the type of water-soluble alkaline compound used; for example, preferably it is 1.0% by weight or higher but no higher than 10.0% by weight relative to the weight of the base paper in the case of sodium carbonate, or 0.4% by weight or higher but no higher than 3.8% by weight relative to the weight of the base paper in the case of sodium hydroxide.

### Carboxyalkyl Cellulose Salt

Preferably the base paper of the water-soluble paper proposed by the present invention contains a carboxyalkyl cellulose salt in addition to the papermaking fibers and water-soluble alkaline compound. Combined use of the water-soluble alkaline compound and carboxyalkyl cellulose salt allows for further improvement of dispersibility in water.

Carboxyalkyl cellulose salts are natural celluloses, recycled celluloses, refined celluloses, and other celluloses that have been carboxyalkylated according to known methods, and their aqueous solutions show neutrality (pH 6 to 8). Specifically, carboxyalkyl cellulose salts include carboxymethyl cellulose sodium salt, carboxyethyl cellulose sodium salt, etc., of which carboxymethyl cellulose salt is preferred from the viewpoint of improving the dispersibility in water and strength.

Preferably the percentage of the carboxyalkyl cellulose salt relative to the weight of the base paper is 2.0% by weight or higher but no higher than 12.0% by weight relative to the weight of the base paper. If the percentage of the carboxyalkyl cellulose salt is lower than 2.0% by weight, the effect of improving the dispersibility in water becomes poor; if it exceeds 12.0% by weight, on the other hand, a film may form on the surface of the water-dispersible paper and cause the water permeation into the paper to deteriorate and its dispersibility in water to drop. More preferably the content ratio of the carboxyalkyl cellulose salt relative to the weight of the base paper is 3.0% by weight or higher but no higher than 6.0% by weight.

Preferably the degree of etherification of the carboxyalkyl cellulose salt is 0.2 or higher but no higher than 1.1. It should be noted that the “degree of etherification” refers to the degree of substitution of carboxyalkyl groups. If the degree of etherification is lower than 0.2, an increase in gel components may lead to lower solubility in water. If the degree of etherification exceeds 1.1, on the other hand, the rate of dissolution in water may drop in an alkaline condition. More preferably the degree of etherification is 0.6 or higher but no higher than 0.8.

Preferably the carboxyalkyl cellulose salt has a type B viscosity in a 2.5 percent aqueous solution (hereinafter also referred to simply as “type B viscosity”) of 5 mPa·s or higher but no higher than 3,500 mPa·s. A type B viscosity under 5 mPa·s leads to a low manufacturing yield of carboxyalkyl cellulose salt and causes the cost of the water-dispersible paper to increase, which is not desirable. If the type B viscosity exceeds 3,500 mPa·s, on the other hand, a film may form on the surface of the water-dispersible paper and cause the water permeation into the paper to deteriorate and its dispersibility in water to drop, which is not desirable. More preferably the type B viscosity of the carboxyalkyl cellulose salt is 8 mPa·s or higher but no higher than 3,000 mPa·s.

Preferably the base paper contains a water-insoluble powder or marginally water-soluble powder in addition to the papermaking fibers and water-soluble alkaline compound. By containing a water-insoluble powder or marginally water-soluble powder, the base paper can have such benefits as higher dispersibility in water, whiteness, opacity, and smoothness. For the water-insoluble powder or marginally water-soluble powder, a metal compound powder, water-insoluble inorganic salt, marginally water-soluble inorganic salt, thermosetting resin powder, thermoplastic resin powder, etc., may be used. Any of these may be used alone or two or more types may be combined.

Specific examples of water-insoluble powders are as follows: aluminum oxide, titanium dioxide, and other metal oxides. Aluminum hydroxide, zinc hydroxide, and other metal hydroxides. Silicon carbide, boron carbide, and other carbides. Trisilicon tetranitride, boron nitride, and other nitrides. Mica, feldspar group, silica mineral group, clay minerals, synthetic zeolites, natural zeolites, and other silicate minerals. Potassium titanate, barium titanate, and other titanate compounds. Magnesium silicate and other silicate compounds. Zinc phosphate and other phosphate compounds. Vinyl chloride resin, polystyrene resin, urea/formalin resin, melamine-based resin, styrene/butadiene-based copolymer resin, phenol resin, plastic hollow grains, and other organic fillers.

Specific examples of marginally water-soluble powders are as follows: calcium hydroxide, magnesium hydroxide, and other metal hydroxides. Calcium carbonate, barium carbonate, magnesium carbonate, zinc carbonate, and other carbonate compounds. Barium sulfate, calcium sulfate, strontium sulfate, and other sulfate compounds.

Such water-insoluble powder or marginally water-soluble powder is added to the papermaking fiber material, so that it will be contained in the formed base paper by 5% by weight or more but no more than 50% by weight. If the quantity of the water-insoluble or marginally water-soluble powder contained in the base paper is under 5% by weight, the effect of improving the dispersibility in water or whiteness may become extremely small. If the quantity of the water-insoluble or marginally water-soluble powder exceeds 50% by weight, on the other hand, the tensile strength may drop significantly, and the ease of papermaking may deteriorate.

### Method for Manufacturing Base Paper

The base paper can be obtained by adding the water-soluble alkaline compound to a sheet formed from a paper material containing the papermaking fibers using any known papermaking technology.

Any paper machine may be used, such as cylinder paper machine, inclined short screen paper machine, Fourdrinier paper machine, twin-wire paper machine, etc., according to the required strength and dispersibility in water. If a cylinder paper machine is used, for example, a water-dispersible paper that has large strength anisotropy in that it is weaker in the horizontal direction than in the longitudinal direction, and thus breaks easily in the horizontal direction into thin strips in water, can be obtained.

The sheet may be formed as a single-layer sheet, or it may be formed as a multi-layer sheet by manufacturing multiple wet papers from the same or different paper materials using a paper machine having two or more papermaking screens and then combining the wet papers.

The method for adding the water-soluble alkaline compound to the sheet is not limited in any way, and any method may be used such as coating it with a coating machine, spraying it using a sprayer, or depositing it on a felt, etc., to be transferred therefrom, for example. Also, the carboxyalkyl cellulose salt may be added to the sheet using similar methods. The carboxyalkyl cellulose salt may be mixed with the water-soluble alkaline compound and added together, or it may be added separately from the water-soluble alkaline compound.

Among the aforementioned methods, the addition by coating is preferred in that the water-soluble alkaline compound and carboxyalkyl cellulose salt can be added to the base paper accurately and evenly. The coating method is not limited in any way and the coating may be performed using a roll coater, gravure coater, air-knife coater, bar coater, blade coater, curtain coater, champlex coater, or other coating machine.

The basis weight of the base paper is not limited in any way, but normally in a range of 10 g/m² or more but no more than 200 g/m². Particularly as a base paper of a coated paper to be printed on, its basis weight is preferably 50 g/m² or more, and preferably no more than 120 g/m².

### [Water-Dispersible Paper]

The water-dispersible paper proposed by the present invention is such that its base paper may be used alone or an adhesive layer, or coating layer may be provided thereon depending on the application. For example, a water-dispersible paper having an adhesive layer on one side, and a coating layer on the other side, of its base paper may be utilized in applications that, for example, require the water-dispersible paper to be attached on a container, returnable container, or other adhered as an adhesive label having a printed surface, and to be removed with ease from the adhered when washed with water after use.

### [Adhesive Layer]

The water-dispersible paper proposed by the present invention may have an adhesive layer at least on one side of the base paper.

The adhesive that constitutes the adhesive layer of the water-dispersible paper is preferably an adhesive having solubility or redispersibility in water, or more preferably a water-soluble acrylic-based adhesive or water-redispersible acrylic-based adhesive. Examples of water-soluble acrylic-based adhesives include, for example, those that contain, as a base polymer, any of copolymers constituted by alkoxy alkyl acrylate, styrene sulfonic acid salt, and other copolymeric monomers, or copolymers constituted by (meta)acrylic acid or other carboxyl group-containing vinyl-based monomers, hydroxyl group-containing monomers, and if used depending on the situation, other copolymerizable monomers.

Examples of water-redispersible acrylic-based adhesives include, for example, those that contain, as a base polymer, any of copolymers constituted by (meta)acrylic acid alkyl ester, carboxyl group-containing vinyl-based monomers, alkoxy group-containing vinyl-based monomers, and if used depending on the situation, other copolymerizable monomers, or copolymers obtained through copolymerization of carboxylated rosin ester-containing vinyl-based monomers, carboxyl group-containing vinyl-based monomers, and water-soluble vinyl-based monomers. It should be noted that the carboxyl groups in these copolymers may be of a type of salt that has been partially or entirely neutralized with an alkali as necessary, where an alkaline metal salt, amine salt, or alkanol amine salt is used favorably for this alkaline.

If a water-soluble acrylic-based adhesive or water-redispersible acrylic-based adhesive is used, the adhesive layer coating solution with which to form an adhesive layer may have a crosslinking agent compounded in it to adjust the adhesive force or solubility or dispersibility in water. Such crosslinking agent is not limited in any way, and any crosslinking agent commonly used in conventional acrylic-based adhesives may be used. Examples include 1,2-ethyelne diisocyanate and other isocyanate-based crosslinking agents, diglycidyl ethers and other epoxy-based crosslinking agents, melamine resins, urea resins, dialdehydes, methylol polymers, metal chelate compounds, metal alkoxides, metal salts, etc. Furthermore, the adhesive layer coating solution may have any conventionally known plasticizer, tackifier, colorant, thickening agent, defoaming agent, leveling agent, plasticizer, antifungal agent, antioxidant, etc., compounded in it as deemed appropriate in order to adjust its properties and enhance its performance as necessary. Here, preferred plasticizers and tackifiers are those soluble or dispersible in water, where such plasticizers include, for example, sugar alcohols and other polyalcohols, polyether polyols, and alkanol amine salts of rosin oxides, etc., while such tackifiers include, for example, alkaline metal salts of rosin, disproportionated rosin, hydrogenated rosin, etc., ammonium salts, and polyether esters, etc.

An adhesive layer may be provided by directly coating the adhesive layer coating solution at least on one side of the base paper, or an adhesive layer that has been formed on a release sheet may be transferred onto the base paper. An adhesive layer may be provided at least on one side of the base paper in a manner covering the surface entirely or partially. Providing an adhesive layer partially allows, for example, for easy releasing of a release paper attached over the adhesive layer.

The coating weight of the adhesive layer is preferably 3 g/m² or more but no more than 60 g/m², or more preferably 10 g/m² or more but no more than 50 g/m², in solids content. If the adhesive coating weight is under 3 g/m², the bonding performance of the obtained adhesive sheet will become insufficient; if it exceeds 60 g/m², on the other hand, the adhesive will likely ooze out during the manufacturing of the adhesive sheet or in post processes, which is not desirable.

Preferably a release sheet is attached over the adhesive layer to prevent it from sticking unnecessarily except when in use, so that the release sheet would be peeled as desired at the time of use. The release sheet is not limited in any way, and any of conventionally known release sheets, such as glassine paper, coated paper, cast coated paper, and other paper base materials, laminated papers comprising these paper base materials having polyethylene or other thermoplastic resin laminated thereon, as well as polyethylene terephthalate, polypropylene, polyethylene, and various other plastic films coated with a silicone resin or other release agent on one side or both sides, may be used. The basis weight of the release sheet is not limited in any way, but normally 20 g/m² or more but no more than 120 g/m² or so.

Also, an adhesive may be partially applied by a printing method on one side of base papers in dotted, rectangular, or other discontinuous patterns, with a release agent partially applied on the other side of base papers in patterns matching the adhesive patterns, after which the base papers are stacked with their partial adhesive application side and partial release-agent application side facing each other, to form a laminate of water-dispersible papers requiring no release sheet.

### [Coating Layer]

The water-dispersible paper proposed by the present invention may have a coating layer comprising an aqueous coating material at least on one side of the base paper. A coating layer may be provided alone, or it may be provided together with an adhesive layer, on the base paper. In the latter case, preferably the coating layer is provided on the side of the base paper opposite the adhesive layer.

The coating layer is not limited in any way so long as it is a layer formed by coating/drying an aqueous coating material, and may be an ink receiving layer, heat seal layer, etc., for example. Also, multiple coating layers may be provided.

Examples of coating layers suitable for gravure printing and flexographic printing are given below.

When adapting the water-dispersible paper proposed by the present invention to gravure printing or flexographic printing, preferably it has a pigment coat layer whose primary components are a pigment and an aqueous binder, or a clear coat layer whose primary component is an aqueous binder, at least on one side of the water-dispersible paper. Providing such coating layer by application increases the smoothness of the base paper surface, which is high in freeness and relatively porous, and thereby improves the ink receptivity.

For the pigment, binder, and various additives, etc., to be compounded in this coating layer, any known substances may be selected and used as deemed appropriate according to the desired printability, etc.

Pigments include inorganic pigments such as calcium carbonate, clay, kaolin, calcine kaolin, diatomaceous earth, talc, titanium oxide, aluminum hydroxide, magnesium carbonate, zinc oxide, aluminum oxide, magnesium hydroxide, barium sulfate, calcium sulfate, zinc sulfate, calcium silicate, aluminum silicate, magnesium silicate, sodium aluminosilicate, magnesium aluminosilicate, silica, colloidal silica, and calcium carbonate complex silica, as well as organic pigments such as melamine resin pigments, urea-formalin resin pigments, polyethylene powders, nylon powders, styrene, styrene-acrylic, and acrylic.

Preferred binders are water-soluble resins or water-dispersible resins, or specifically starches, hydroxyethyl cellulose, methyl cellulose, and carboxymethyl cellulose salts, gelatin, casein, sodium alginate, polyvinyl alcohols, modified polyvinyl alcohols, polyvinyl pyrrolidone, polyacrylamides, acrylamide/acrylic acid ester copolymers, styrene/maleic acid anhydride copolymers and alkaline salts thereof, ethylene/maleic acid anhydride copolymers and alkali salts thereof, styrene/butadiene copolymers, sodium polyacrylate, vinyl acetate, ethylene-vinyl acetate, acrylic acid copolymers, methacrylic acid copolymers, acrylic acid/methacrylic acid copolymers, etc. Among these, desirably one of starches, hydroxyethyl cellulose, methyl cellulose, and carboxymethyl cellulose salts, gelatin, casein, sodium alginate, polyvinyl alcohols, modified polyvinyl alcohols, and polyvinyl pyrrolidone, which are water-soluble resins, is contained as a binder from the viewpoint of dispersibility in water.

Various additives include cationic resin (printability improving agent), pigment dispersant, defoaming agent, lubricant, UV absorbent, sizing agent, fluorescent dye, preservative, etc.

The coating machine with which to form a coating layer is not limited in any way, and an air-knife coater, bar coater, roll coater, blade coater, curtain coater, cast coater, champlex coater, gravure coater, 2-roll coater, transfer-roll coater, etc., may be used.

### EXAMPLES

The present invention is explained in greater detail below using examples; it should be noted, however, that the constitutions of the present invention are not limited to these examples.

### Example 1

20% by weight of softwood bleached kraft pulp and 80% by weight of hardwood kraft pulp were mixed and beaten to a Canadian Standard Freeness of 500 ml CSF, after which a filler (calcium carbonate) was added by 17% by weight relative to the total quantity of pulp, and the mixture was formed into a base paper with a basis weight of 45 g/m² using a Fourdrinier paper machine.

An aqueous solution of a water-soluble alkaline compound (sodium carbonate, Soda Ash Light, manufactured by Tokuyama Corporation) was coated on the obtained base paper by the sizing press method so that the water-soluble alkaline compound would account for 8.0% by weight, to produce a water-dispersible paper.

### Example 2

62% by weight of bleached softwood kraft pulp and 38% by weight of hardwood dissolving pulp were mixed and beaten to a Canadian Standard Freeness of 600 ml CSF, after which the mixture was formed into a base paper with a basis weight of 53 g/m² using a Fourdrinier paper machine.

A water-dispersible paper was produced in the same manner as in Example 1, except that the aqueous solution was coated on the obtained base paper so that the water-soluble alkaline compound would account for 8.3% by weight.

### Example 3

A water-dispersible paper was produced in the same manner as in Example 2, except that an aqueous solution in which a water-soluble alkaline compound (sodium carbonate, Soda Ash Light, manufactured by Tokuyama Corporation) and a carboxyalkyl cellulose salt (powder of carboxymethyl cellulose sodium salt (hereinafter also referred to as “CMC salt”), product name SUNROSE APP84, manufactured by Nippon Paper Industries Co., Ltd., degree of etherification 0.75, type B viscosity 8 mPa·s) had been dissolved was coated on the base paper so that the water-soluble alkaline compound would account for 8.3% by weight and the CMC salt, 4.1% by weight.

### Example 4

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE SLD-F1, manufactured by Nippon Paper Industries Co., Ltd., degree of etherification 0.2, type B viscosity 300 mPa·s) had been dissolved was coated on the base paper so that the water-soluble alkaline compound would account for 8.1% by weight and the CMC salt, 4.1% by weight.

### Example 5

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F10LC, manufactured by Nippon Paper Industries Co., Ltd., degree of etherification 0.55, type B viscosity 1,400 mPa·s) had been dissolved was coated on the base paper so that the water-soluble alkaline compound would account for 8.1% by weight and the CMC salt, 4.0% by weight.

### Example 6

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F30LC, manufactured by Nippon Paper Industries Co., Ltd., degree of etherification 0.65, type B viscosity 1,940 mPa·s) had been dissolved was coated on the base paper so that the water-soluble alkaline compound would account for 8.5% by weight and the CMC salt, 4.3% by weight.

### Example 7

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F100HC, manufactured by Nippon Paper Industries Co., Ltd., degree of etherification 1.0, type B viscosity 3,100 mPa·s) had been dissolved was coated on the base paper so that the water-soluble alkaline compound would account for 8.0% by weight and the CMC salt, 4.0% by weight.

### Example 8

Bleached softwood kraft pulp alone was beaten to a Canadian Standard Freeness of 700 ml CSF, which was then hand-made into a base paper with a basis weight of 53 g/m².

An aqueous solution in which a water-soluble alkaline compound (sodium carbonate, Soda Ash Light, manufactured by Tokuyama Corporation) and a CMC salt (product name SUNROSE APP84, manufactured by Nippon Paper Industries Co., Ltd., degree of etherification 0.75, type B viscosity 8 mPa·s) had been dissolved was coated on the obtained base paper so that the water-soluble alkaline compound would account for 10.4% by weight and the CMC salt, 2.6% by weight, to produce a water-dispersible paper.

### Example 9

A water-dispersible paper was produced in the same manner as in Example 8, except that it was coated on the base paper so that the water-soluble alkaline compound would account for 4.4% by weight and the CMC salt, 7.3% by weight.

### Example 10

A water-dispersible paper was produced in the same manner as in Example 8, except that it was coated on the base paper so that the water-soluble alkaline compound would account for 2.2% by weight and the CMC salt, 8.6% by weight.

### Example 11

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F10LC, manufactured by Nippon Paper Industries Co., Ltd., degree of etherification 0.55, type B viscosity 1,400 mPa·s) had been dissolved was coated on the base paper so that the water-soluble alkaline compound would account for 2.5% by weight and the CMC salt, 4.2% by weight.

### Example 12

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F30LC, manufactured by Nippon Paper Industries Co., Ltd., degree of etherification 0.65, type B viscosity 1,940 mPa·s) had been dissolved was coated on the base paper so that the water-soluble alkaline compound would account for 2.6% by weight and the CMC salt, 4.3% by weight.

### Example 13

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE APP84, manufactured by Nippon Paper Industries Co., Ltd., degree of etherification 0.75, type B viscosity 8 mPa·s) had been dissolved was coated on the base paper so that the water-soluble alkaline compound would account for 2.4% by weight and the CMC salt, 4.0% by weight.

### Example 14

A water-dispersible paper was produced in the same manner as in Example 2, except that an aqueous solution in which a water-soluble alkaline compound (sodium carbonate, Soda Ash Light, manufactured by Tokuyama Corporation) and a CMC salt (product name SUNROSE F100HC, manufactured by Nippon Paper Industries Co., Ltd., degree of etherification 1.0, type B viscosity 3,100 mPa·s) had been dissolved was coated on the base paper so that the water-soluble alkaline compound would account for 2.3% by weight and the CMC salt, 3.9% by weight.

### Example 15

An adhesive layer coating solution compounded as follows was applied by 25 g/m² in solids content on the release-treated side of a release sheet (35SIP, manufactured by Nippon Paper Papylia Co., Ltd., basis weight 36 g/m²) to which a silicone release agent had been applied, and then dried, to create a release sheet with adhesive layer.

### <Adhesive Layer Coating Solution>

Water-soluble acrylic-based adhesive (Riki-Dyne AR-2410, manufactured by VIGteQnos Co., Ltd., solids content concentration 42% by weight) 100 parts by weight

Curing agent (Sunpasta HD-5013, manufactured by VIGteQnos Co., Ltd.) 0.1 parts by weight

Using the water-dispersible paper produced in Example 3 as a base paper, the adhesive layer of the release sheet with adhesive layer was attached over this base paper, to produce a water-dispersible paper having an adhesive layer on one side. It should be noted that this water-dispersible paper with adhesive layer had an adhesive force of 560 g/25 mm, as measured by a 180-degree peel test from a stainless steel plate 8 hours after the application according to JIS Z0237, indicating that it had sufficient adhesive force.

### Example 16

Using the water-dispersible paper obtained in Example 3 as a base paper, an aqueous coating solution compounded from 70 parts by weight of kaolin, 30 parts by weight of calcium carbonate, and 75 parts by weight of hydroxyethylated starch (product name Coat Master, manufactured by Sansho Co., Ltd.) was coated, using a gravure coater, on one side of this base paper to a deposited quantity of 5 g/m² in solids content, followed by supercalendering at a line pressure of 150 kg/cm and temperature of 80° C., to obtain a water-dispersible paper with coating layer.

The coating layer of the obtained water-dispersible paper was printed on with a blue oil-based gravure ink (GFP Color Indigo Blue, manufactured by Dainichiseika Color & Chemicals Mfg. Co., Ltd.) using a tabletop gravure printing tester. The printed finish on this water-dispersible paper presented no problems in practical use.

### Comparative Example 1

17% by weight of softwood bleached kraft pulp and 83% by weight of hardwood kraft pulp were mixed and beaten to a Canadian Standard Freeness of 400 ml CSF, after which a filler (calcium carbonate) was added by 22% by weight relative to the total quantity of pulp, and the mixture was formed into a coating base paper with a basis weight of 36 g/m² using a Fourdrinier paper machine.

### Comparative Example 2

An aqueous solution of a water-soluble alkaline compound (sodium carbonate, Soda Ash Light, manufactured by Tokuyama Corporation) was coated on the base paper obtained in Comparative Example 1 by the sizing press method so that the water-soluble alkaline compound would account for 2.0% by weight, to produce a water-dispersible paper.

### Comparative Example 3

A water-dispersible paper was produced in the same manner as in Comparative Example 2, except that the aqueous solution was coated by the sizing press method so that the water-soluble alkaline compound would account for 6.5% by weight.

### Comparative Example 4

A water-dispersible paper was produced in the same manner as in Comparative Example 2, except that an aqueous solution in which a CMC (product name SUNROSE APP84, manufactured by Nippon Paper Industries Co., Ltd., degree of etherification 0.75, type B viscosity 8 mPa·s) had been dissolved was coated on the base paper by the sizing press method so that the CMC salt would account for 5.9% by weight.

### Comparative Example 5

A water-dispersible paper was produced in the same manner as in Comparative Example 2, except that an aqueous solution in which a water-soluble alkaline compound (sodium carbonate, Soda Ash Light, manufactured by Tokuyama Corporation) and a CMC salt (product name SUNROSE APP84, manufactured by Nippon Paper Industries Co., Ltd., degree of etherification 0.75, type B viscosity 8 mPa·s) had been dissolved was coated on the base paper by the sizing press method so that the water-soluble alkaline compound would account for 6.1% by weight and the CMC salt, 6.1% by weight.

### Comparative Example 6

The base paper formed in Example 2 was used directly.

### Comparative Example 7

A water-dispersible paper was produced in the same manner as in Example 4, except that no water-soluble alkaline compound was coated.

### Comparative Example 8

A water-dispersible paper was produced in the same manner as in Example 5, except that no water-soluble alkaline compound was coated.

### Comparative Example 9

A water-dispersible paper was produced in the same manner as in Example 6, except that no water-soluble alkaline compound was coated.

### Comparative Example 10

A water-dispersible paper was produced in the same manner as in Example 7, except that no water-soluble alkaline compound was coated.

### Comparative Example 11

The base paper formed in Example 8 was used directly.

The water-dispersible papers and base papers obtained in the Examples and Comparative Examples above were evaluated below. The results are shown in Tables 1 and 2.

### 1) Dispersibility in Water

A 3-cm square test piece was introduced into a 300-ml beaker containing 300 ml of deionized water being agitated with a stirrer at 650 rpm. The time it took for the test piece to break into two or more thin pieces was measured as the small floc state dispersion time in water, while the time it took for the test piece to disintegrate into individual fibers was measured as the fibrous dispersion time in water. Each of these times was obtained as an average value of five measurements performed with a stopwatch, and evaluated as follows.

⊚: The small floc state dispersion time in water is within 5 seconds and the fibrous dispersion time in water is within 60 seconds.

◯: The small floc state dispersion time in water exceeds 5 seconds but is within 10 seconds and the fibrous dispersion time in water is within 100 seconds, or the small floc state dispersion time in water is within 10 seconds and the fibrous dispersion time in water exceeds 60 seconds but is within 100 seconds.

Δ: The small floc state dispersion time in water exceeds 10 seconds but is within 100 seconds and the fibrous dispersion time in water is within 200 seconds, or the small floc state dispersion time in water is within 100 seconds and the fibrous dispersion time in water exceeds 100 seconds but is within 200 seconds. It is evaluated that the paper is dispersible in water.

x: The small floc state dispersion time in water exceeds 100 seconds or the fibrous dispersion time in water exceeds 200 seconds. It is evaluated that dispersing the paper in water is difficult.

### 2) Tensile Test

A water-dispersible paper sample that had been stored for at least 24 hours in an ambience of 23° C., 50% RH was measured according to JIS P8113.

### 3) Air Permeability

Using an air permeability manual measuring device (PPM100, manufactured by Filtrona Instruments & Automation Ltd.), the volume of air that passes through 1 cm² of sample per minute was measured under a differential pressure of 100 mmH₂O.

### 4) Whiteness

Using a spectrophotometer-type colorimeter (ColorTouch, manufactured by Technidyne Corporation), the diffuse reflectance of blue light was measured according to JIS P8212.

TABLE 1

| Examples | 1 | 2 | 3 | 4 | 5 | 6 | 7 | 8 | 9 | 10 |
|---|---|---|---|---|---|---|---|---|---|---|
| Freeness of papermaking | 500 | 600 | 600 | 600 | 600 | 600 | 600 | 700 | 700 | 700 |
| fibers ml CSF | | | | | | | | | | |
| Content of alkaline | 8.0 | 8.3 | 8.3 | 8.1 | 8.1 | 8.5 | 8.0 | 10.4 | 4.4 | 2.2 |
| compound % by weight | | | | | | | | | | |
| (relative to base paper) | | | | | | | | | | |
| Content of CMC salt % | — | — | 4.1 | 4.1 | 4.0 | 4.3 | 4.0 | 2.6 | 7.3 | 8.6 |
| by weight (relative to | | | | | | | | | | |
| base paper) | | | | | | | | | | |
| Degree of etherification | — | — | 0.75 | 0.2 | 0.55 | 0.65 | 1.0 | 0.75 | 0.75 | 0.75 |
| Type B viscosity mPa · s | — | — | 8 | 300 | 1400 | 1940 | 3100 | 8 | 8 | 8 |
| Evaluation of | O | O | ⊚ | O | O | O | O | O | ⊚ | ⊚ |
| dispersibility in water | | | | | | | | | | |
| Small floc state | 9.6 | 5.9 | 2.0 | 5.0 | 9.0 | 9.6 | 6.9 | 6.8 | 4.2 | 3.7 |
| dispersion time | | | | | | | | | | |
| in water sec | | | | | | | | | | |
| Fibrous dispersion | 98.8 | 29.6 | 19.2 | 66.0 | 94.5 | 61.6 | 63.8 | 68.0 | 36.9 | 29.2 |
| time in water sec | | | | | | | | | | |
| Air permeability ml/min | 84 | 1168 | 767 | 523 | 156 | 367 | 412 | — | — | — |
| Tensile strength | 1.58 | 0.98 | 2.45 | 2.06 | 3.62 | 4.00 | 3.86 | 2.64 | 3.56 | 3.75 |
| MD kN/m | | | | | | | | | | |
| Whiteness % | 89.0 | 84.0 | 83.0 | 82.9 | 80.9 | 79.7 | 80.1 | 75.0 | — | — |
| | | | | Examples | 11 | 12 | 13 | 14 | 15 | 16 |
| | | | | Freeness of papermaking | 600 | 600 | 600 | 600 | 600 | 600 |
| | | | | fibers ml CSF | | | | | | |
| | | | | Content of alkaline | 2.5 | 2.6 | 2.4 | 2.3 | 8.3 | 8.3 |
| | | | | compound % by weight | | | | | | |
| | | | | (relative to base paper) | | | | | | |
| | | | | Content of CMC salt % | 4.2 | 4.3 | 4.0 | 3.9 | 4.1 | 4.1 |
| | | | | by weight (relative | | | | | | |
| | | | | to base paper) | | | | | | |
| | | | | Degree of etherification | 0.55 | 0.65 | 0.75 | 1.0 | 0.75 | 0.75 |
| | | | | Type B viscosity mPa · s | 1400 | 1940 | 8 | 3100 | 8 | 8 |
| | | | | Evaluation of | O | O | ⊚ | ⊚ | O | O |
| | | | | dispersibility in water | | | | | | |
| | | | | Small floc state | 3.3 | 3.4 | 2.3 | 3.3 | 8.8 | 9.5 |
| | | | | dispersion time | | | | | | |
| | | | | in water sec | | | | | | |
| | | | | Fibrous dispersion | 87.5 | 63.7 | 25.6 | 59.4 | 41.0 | 61.0 |
| | | | | time in water sec | | | | | | |
| | | | | Air permeability ml/min | 321 | 658 | 1148 | 715 | — | — |
| | | | | Tensile strength | 3.77 | 3.93 | 2.09 | 3.85 | 2.71 | 3.78 |
| | | | | MD kN/m | | | | | | |
| | | | | Whiteness % | 82.5 | 80.8 | 83.5 | 80.9 | — | — |

TABLE 2

| Comparative | | | | | | | | | | | |
|---|---|---|---|---|---|---|---|---|---|---|---|
| Examples | 1 | 2 | 3 | 4 | 5 | 6 | 7 | 8 | 9 | 10 | 11 |
| Freeness of | 400 | 400 | 400 | 400 | 400 | 600 | 600 | 600 | 600 | 600 | 700 |
| papermaking | | | | | | | | | | | |
| fibers ml | | | | | | | | | | | |
| CSF | | | | | | | | | | | |
| Content of | — | 2.0 | 6.5 | — | 6.1 | — | — | — | — | — | — |
| alkaline | | | | | | | | | | | |
| compound % | | | | | | | | | | | |
| by weight | | | | | | | | | | | |
| (relative to | | | | | | | | | | | |
| base paper) | | | | | | | | | | | |
| Content of | — | — | — | 5.9 | 6.1 | — | 4.1 | 4.0 | 4.3 | 4.0 | — |
| CMC salt % | | | | | | | | | | | |
| by weight | | | | | | | | | | | |
| (relative to | | | | | | | | | | | |
| base paper) | | | | | | | | | | | |
| Degree of | — | — | — | 0.75 | 0.75 | — | 0.2 | 0.55 | 0.65 | 1.0 | — |
| etherification | | | | | | | | | | | |
| Type B | — | — | — | 8 | 8 | — | 300 | 1400 | 1940 | 3100 | — |
| viscosity | | | | | | | | | | | |
| mPa·s | | | | | | | | | | | |
| Evaluation of | x | x | x | x | x | x | x | Δ | Δ | Δ | x |
| dispersibility | | | | | | | | | | | |
| in water | | | | | | | | | | | |
| Small floc | 200 | 210 | 225 | 213 | 130 | 20.4 | 2.9 | 3.5 | 3.1 | 3.1 | 21 |
| state | | | | | | | | | | | |
| dispersion | | | | | | | | | | | |
| time in water | | | | | | | | | | | |
| sec | | | | | | | | | | | |
| Fibrous | >300 | >300 | >300 | >300 | >300 | >300 | >300 | 126.7 | 165.7 | 117.7 | 372 |
| dispersion | | | | | | | | | | | |
| time in water | | | | | | | | | | | |
| sec | | | | | | | | | | | |
| Air | 155 | 147 | 136 | 138 | 116 | 1012 | 523 | 250 | 510 | 598 | — |
| permeability | | | | | | | | | | | |
| ml/min | | | | | | | | | | | |
| Tensile | 1.31 | 1.24 | 1.24 | 2.84 | 2.87 | 1.78 | 3.2 | 3.87 | 3.58 | 3.64 | 1.51 |
| strength MD | | | | | | | | | | | |
| kN/m | | | | | | | | | | | |
| Whiteness % | 88.1 | 86.5 | 86.3 | 86.5 | 84.8 | 87.3 | 86.2 | 85.7 | 85.2 | 85.5 | — |

The water-dispersible papers obtained in the Examples, which were conforming to the present invention, had excellent dispersibility in water. Particularly from Examples 4 to 7 containing a water-soluble alkaline compound, and Comparative Examples 7 to 10 not containing any water-soluble alkaline compound, it was confirmed that a water-soluble alkaline compound would markedly improve dispersibility in water.

The water-dispersible papers obtained in Comparative Examples 1 to 5 had poor dispersibility in water because their papermaking fibers were low in freeness.

1. A water-dispersible paper characterized by having a base paper containing papermaking fibers and a water-soluble alkaline compound, wherein a Canadian Standard Freeness of the papermaking fibers is 500 ml CSF or higher but no higher than 750 ml CSF.

2. The water-dispersible paper according to claim 1, characterized in that the base paper contains a carboxyalkyl cellulose salt.

3. The water-dispersible paper according to claim 1, characterized in that the base paper contains either of a water-insoluble powder or a marginally water-soluble powder or both.

4. The water-dispersible paper according to claim 1, characterized by having an adhesive layer at least on one face.

5. The water-dispersible paper according to claim 1, characterized by having a coating layer comprising an aqueous coating material at least on one face.

6. The water-dispersible paper according to claim 5, characterized by having an adhesive layer on one face, and the coating layer on the other face, of the base paper.

7. The water-dispersible paper according to claim 2, characterized in that the base paper contains either of a water-insoluble powder or a marginally water-soluble powder or both.

8. The water-dispersible paper according to claim 2, characterized by having an adhesive layer at least on one face.

9. The water-dispersible paper according to claim 2, characterized by having a coating layer comprising an aqueous coating material at least on one face.

10. The water-dispersible paper according to claim 3, characterized by having an adhesive layer at least on one face.

11. The water-dispersible paper according to claim 3, characterized by having a coating layer comprising an aqueous coating material at least on one face.

12. The water-dispersible paper according to claim 4, characterized by having a coating layer comprising an aqueous coating material at least on one face.

13. The water-dispersible paper according to claim 7, characterized by having an adhesive layer at least on one face.

14. The water-dispersible paper according to claim 7, characterized by having a coating layer comprising an aqueous coating material at least on one face.

15. The water-dispersible paper according to claim 8, characterized by having a coating layer comprising an aqueous coating material at least on one face.

16. The water-dispersible paper according to claim 9, characterized by having an adhesive layer on one face, and the coating layer on the other face, of the base paper.

17. The water-dispersible paper according to claim 10, characterized by having a coating layer comprising an aqueous coating material at least on one face.

18. The water-dispersible paper according to claim 11, characterized by having an adhesive layer on one face, and the coating layer on the other face, of the base paper.

19. The water-dispersible paper according to claim 12, characterized by having the adhesive layer on one face, and the coating layer on the other face, of the base paper.

20. The water-dispersible paper according to claim 13, characterized by having a coating layer comprising an aqueous coating material at least on one face.
